(19) United States
(12) Patent Application Publication
(10) Pub. No.: US 2007/0153117 A1
(43) Pub. Date: Jul. 5, 2007

(54) Apparatus and method for adjusting display-related setting of an electronic device

(76) Inventors: Yen-Yu Lin, Jhubei City (TW); Chang-Jung Kao, Jhonghe City (TW); Shu-Wen Teng, Taipei City (TW)

Correspondence Address: RABIN & Berdo, PC, 1101 14TH STREET, NW, SUITE 500, WASHINGTON, DC, 20005, US

(21) Appl. No.: 11/320,656

(22) Filed: Dec. 30, 2005

(51) Int. Cl. H04N 5/235; G03B 7/00

(52) U.S. Cl. 348/362

(57) ABSTRACT

An apparatus and method for adjusting display-related setting of an electronic device are disclosed. The apparatus includes an image sensing device, an image signal processing unit, and a determination device. The image sensing device is for capturing a number of images according to a number of exposure time values and outputting image signals accordingly. The image signal processing unit is coupled to the image sensing device for processing the image signals and outputting a number of image luminance values accordingly. The processor is coupled to the image signal processing unit for adjusting the display-related setting of the electronic device according to the image luminance values and exposure time values.

### BACKGROUND OF THE INVENTION

1. Field of the Invention

The invention relates in general to an apparatus and method for adjusting display-related setting of an electronic device, and more particularly to an apparatus and method for adjusting display-related setting of an electronic device according to environment luminance information, which is obtained by processing the image captured from an image sensing device of the electronic device.

2. Description of the Related Art

In terms of portable devices such as mobile phones and personal digital assistants (PDA), the backlight (or frontlight) module disposed in the portable device for illuminating a liquid crystal display (LCD) is usually set to have predetermined backlight intensity in process of fabrication. When the user operates the portable device, he/she can adjust the luminance of the LCD by increasing or decreasing the intensity of backlight via a man-machine interface (MMI) according to his/her sense of sight. Ordinarily speaking, due to the requirement of fixed operation schedules, the user seldom manually adjusts the backlight intensity.

In order to solve the above-mentioned issue of operation inconvenience, a photo sensing device, such as a photo diode, is added to the mobile phone or the PDA, and according to the environment luminance sensed by the photo sensing device, the backlight intensity can be adjusted so as to modulate the luminance of the LCD.

In terms of a transmissive LCD, the intensity of backlight is reduced so as to save system power when the environment luminance is relatively low, and the intensity of backlight is increased when the environment luminance is relatively high.

In terms of a reflective LCD, the frontlight intensity is increased when the environment luminance is relatively low, and the frontlight intensity is lowered so as to reduce system power consumption when the environment luminance is relatively high.

In terms of a transflective LCD, the backlight intensity is increased when the environment luminance is relatively low, and the backlight intensity is lowered when the environment luminance is relatively high.

However, as mentioned above, the method for adjusting the backlight/frontlight intensity according to environment luminance requires an additional photo sensing device to be disposed in the portable device, which increases the cost and occupy a mount of space of the portable device.

Besides, the portable device usually uses a tone reproduction unit (e.g. a gamma correction unit) for performing a tone reproduction-curve mapping (e.g. a gamma-curve mapping) on the multimedia data, such as image or video data and displays the corrected multimedia data on the LCD. Due to the ‘surround effect’ in a human vision system, the gamma correction unit under-compensates the gamma curve (i.e. end-to-end gamma is about 1.1-1.2) in a dim environment and thus the LCD can provide more subjectively pleasing experience of image/video viewing for a user.

However, the images or videos may be viewed in different environments where lighting conditions are different, and therefore, using the same gamma-curve for correction lacks flexibility and cannot ensure the multimedia data is corrected appropriately. Therefore, it is desirable to have a portable device which can overcome this deficiency.

### SUMMARY OF THE INVENTION

It is therefore an object of the invention to provide an apparatus and method for adjusting display-related setting of an electronic device. The environment luminance information is obtained by processing the image signal captured from an image sensing device embedded in the electronic device. The display-related setting of the electronic device can thus be adjusted according to the environment luminance information.

The invention achieves the above-identified object by providing an apparatus for adjusting display-related setting of an electronic device. The apparatus includes an image sensing device, an image signal processing unit, and a determination device. The image sensing device is for capturing a number of images and outputting image signals accordingly. The image signal processing unit is coupled to the image sensing device for processing the image signals and outputting a number of image luminance values accordingly. The determination device is coupled to the image sensing device and the image signal processing unit for controlling the image sensing device to capture the images according to a plurality of exposure time values, and adjusting the display-related setting of the electronic device according to the image luminance values and the exposure time values.

The invention achieves the above-identified object by providing a method for adjusting display-related setting of an electronic device having an image sensing device. The method includes capturing a number of images by the image sensing device according to a number of exposure time values and obtaining image signals accordingly; processing the image signals and obtaining a number of image luminance values accordingly; and adjusting the display-related setting of the electronic device according to the image luminance values and the exposure time values.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of an electronic device according to a preferred embodiment of the invention.

FIG. 2 is a block diagram of another electronic device using a LED backlight module according to a preferred embodiment of the invention.

FIG. 3 is a flow chart of the method for controlling luminance of a display according to the preferred embodiment of the invention.

FIG. 4 is a mapping curve of the exposure time values and the measured image luminance values according to the preferred embodiment of the invention.

FIG. 5 is a block diagram of an electronic device according to a second embodiment of the invention.

FIG. 6 is a flow chart of the luminance compensation method according to the second embodiment of the invention.

### DETAILED DESCRIPTION OF THE INVENTION

### Embodiment One

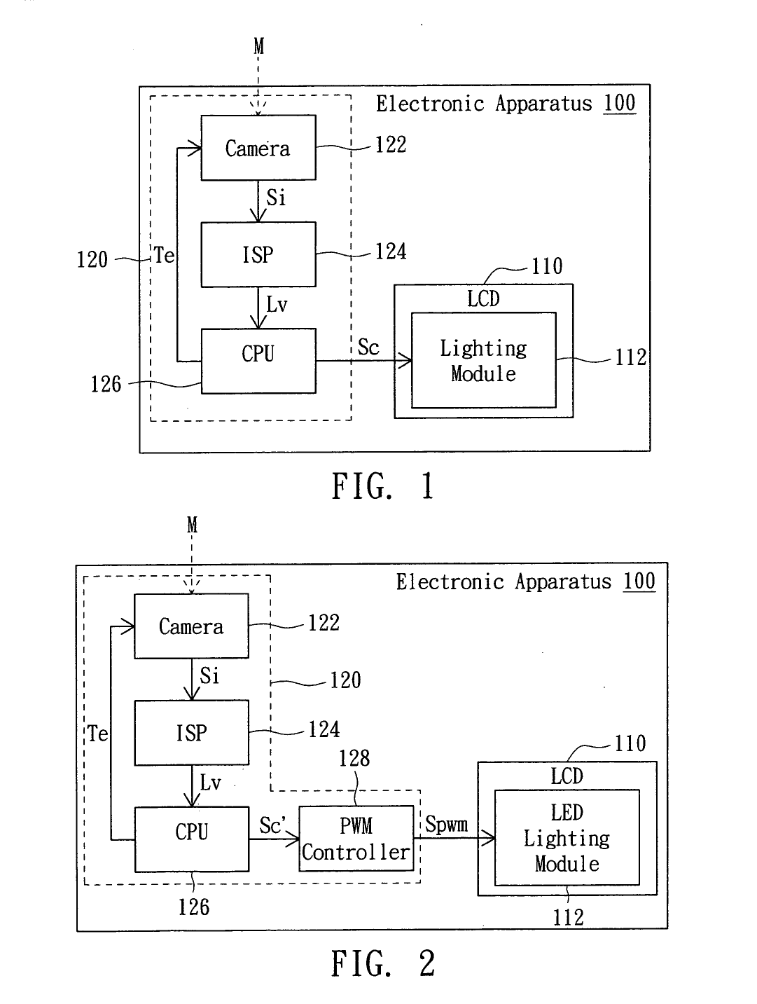

Referring to FIG. 1, a block diagram of an electronic device 100 according to a first embodiment of the invention is shown. The electronic device 100, such as a mobile phone or a PDA, includes a LCD 110 and a display-related setting adjusting apparatus, such as a luminance control apparatus 120 for adjusting the luminance of the LCD 110. The LCD 110 includes a lighting module 112 for illuminating the LCD 110. The lighting module 112 can be a backlight module or a frontlight module based on the type of the LCD 110. When the LCD 110 is a transmissive or transflective LCD, a backlight module is used to be the lighting module 112, and when the CD 110 is a reflective LCD, a frontlight module is used to be the lighting module 112.

The luminance control apparatus 120 includes a camera 122, an image signal processing unit (ISP) 124, and a determination device, such as a central processing unit (CPU) 126. It is noted that the camera 122 is embedded in the electronic device 100 and used for capturing images, and environment luminance information is obtained after processing and analyzing the captured images. Therefore, compared with the prior art, no additional photo sensing device is needed in the present invention. However, the invention is not limited to using the camera 122, and any kind of image sensing device which can be used to capture images of the surroundings so as to achieve the purpose of automatically adjusting the LCD luminance according to environment luminance information also can be applied in the invention.

Generally speaking, the camera 122 comprises a complementary metal oxide semiconductor (CMOS) sensor or a charge coupled device (CCD) for image sensing. The camera 122 is controlled by the CPU 126 for capturing a number of images M from the surroundings of the electronic device 100 according to a number of exposure time values Te, and outputting digital image signals Si accordingly. The ISP 124, coupled to the camera 122, is used for processing the image signals Si and accordingly outputting image luminance values Lv, wherein the luminance values Lv are grey values between 0˜255 for instance. The CPU 126, coupled to the ISP 124, is used for receiving the image luminance values Lv, and according to the image luminance values and the exposure time values Te, generating a control signal Sc to be input outputted to the LCD 110 for adjusting the intensity of the lighting module 112. Therefore, in the present invention, the luminance of the LCD 110 is adjusted according to the image luminance values Lv of the images captured by the camera 122, which carry the environment luminance information.

As shown in FIG. 2, when the LCD 110 uses a light emitting diode (LED) lighting module 112 as a light source, the electronic device 100 further includes a pulse width modulation (PWM) controller 128, coupled to the CPU 126, for outputting a PWM signal Spwm to control the lighting intensity of the LED lighting module 112. Therefore, in some embodiments, according to image luminance values Lv, the CPU 126 generates and outputs a control signal Sc′ to the PWM controller 128 for adjusting the duty of the PWM signal so as to control the luminance of the LCD 110.

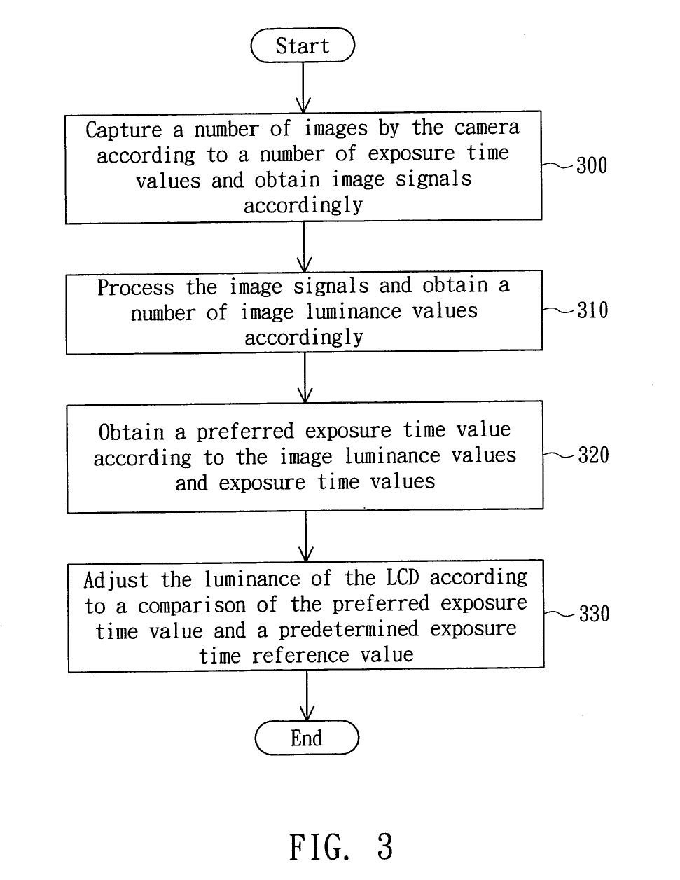

Referring to FIG. 3, a flow chart of the method for controlling luminance of a display according to the first preferred embodiment of the invention is shown. First, in step 300, capture a number of images M, by using the embedded camera 122 for instance, according to a number of exposure time values Te, and obtain image signals Si accordingly. Following that, in step 310, process the image signals Si, by using the ISP 124 for instance, and obtain a number of image luminance values Lv accordingly. Next, in step 320, generate a control signal Sc according to the image luminance values Lv and the exposure time values Te.

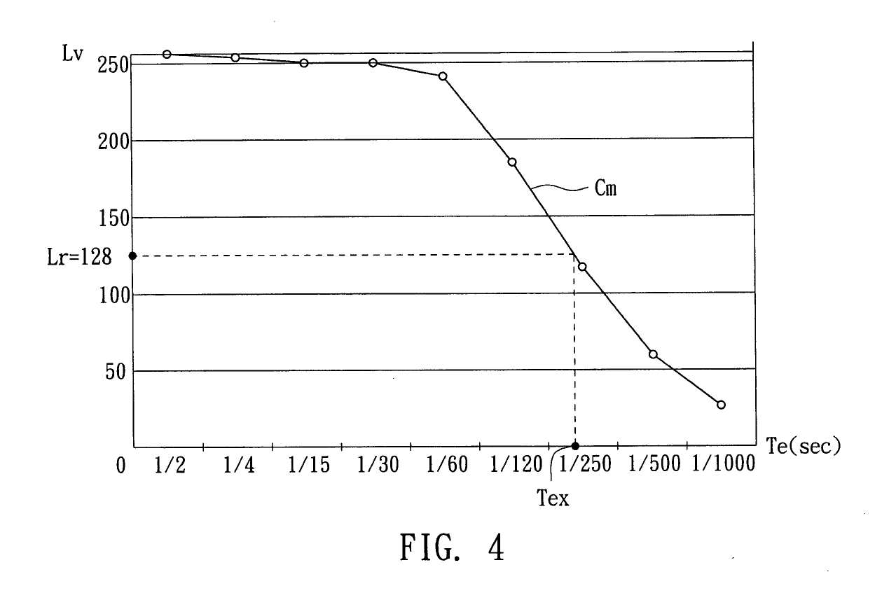

Referring to FIG. 4, a mapping curve of the exposure time values Te and the measured image luminance values Lv according to the invention is shown. As mentioned, the CPU 126 controls the camera 122 to capture nine images M according to nine arbitrary exposure time values Te uniformly distributed between 0 and 1/1000. As shown in FIG. 4, the exposure time values Te are ½, ¼, 1/15, 1/30, 1/60, 1/120, 1/250, 1/500, and 1/1000 sec. ISP 124 then processes the captured nine images so as to generate nine image luminance values, which are 250, 247, 245, 245, 240, 190, 120, 60, and 35. Then, the CPU 126 generates a mapping curve Cm of the nine exposure time values Te and the nine image luminance values Lv as shown in FIG. 4. Thereafter, the CPU bases on a luminance reference value Lr, e.g. 128, to obtain a preferred exposure time value Tex, e.g. 1/250 sec. In a preferred embodiment, the luminance reference value Lr is determined based on the shape of the mapping curve Cm. In order to decide the luminance reference value Lr, a portion of the mapping curve Cm having relatively dramatic slope is determined, and the luminance reference value Lr is corresponding to a substantially middle point of that portion. In most situations, the luminance reference value Lr will be located between 100 and 150, and in this example, the luminance reference value Lr is 128. The CPU then compares the preferred exposure time value Tex with a predetermined exposure time reference value Tre, e.g. 1/100 sec. The predetermined exposure time reference value Tre is determined according to experiments and experiences, and if the preferred exposure time value Tex is greater than the predetermined exposure time reference value Tre, it means the electronic device 100 is located in a relatively dark environment, such as an indoor environment, since longer exposure time is required. Otherwise, it means the electronic device 100 is located in a relatively bright environment, such as an outdoor environment since shorter exposure time is preferred.

Afterwards, in step 330, adjust the luminance of the LCD 110 according to a comparison of the preferred exposure time value Tex and the predetermined exposure time reference value Tre. In this example, Tex is 1/250 and is smaller than Tre, which is 1/100, meaning the electronic device is located in a relatively bright environment. Then, in the step 330, the CPU 126 outputs the control signal Sc to increase the luminance of the lighting module 112 of the LCD 110, where the LCD 110 is a transmissive LCD. When the LCD 110 is a reflective LCD or a transflective LCD, the CPU 126 outputs the control signal Sc to decrease the luminance of the lighting module 112 of the LCD 110.

It should be noted that since the above example has only one exposure time reference value Tre, the luminance of the lighting module 112 of the LCD 110 only can have two statuses, one is off and the other is on. Namely, when Tex is smaller than Tre, the lighting module 112 of the LCD 110 will be turned on, where the LCD 110 is a transmissive LCD. When the LCD 110 is a reflective LCD or a transflective LCD, the lighting module 112 of the LCD 110 will be turned off.

It can be easily understood by the skilled in the art, when the luminance of the lighting module 112 of the LCD 110 has more than two statuses, such as three statuses, which may be noted as off, dark, bright, it needs two exposure time reference values Tre1 and Tre2, where Tre1 is smaller than Tre2. Take a transmissive LCD as an example, when Tex is smaller than Tre1, the lighting module 112 of the LCD 110 will be adjusted to be the status of bright. When Tex is greater than Tre1 and smaller than Tre2, the lighting module 112 of the LCD 110 will be adjusted to be the status of dark. When Tex is greater than Tre2, the lighting module 112 of the LCD 110 will be turned off.

### Embodiment Two

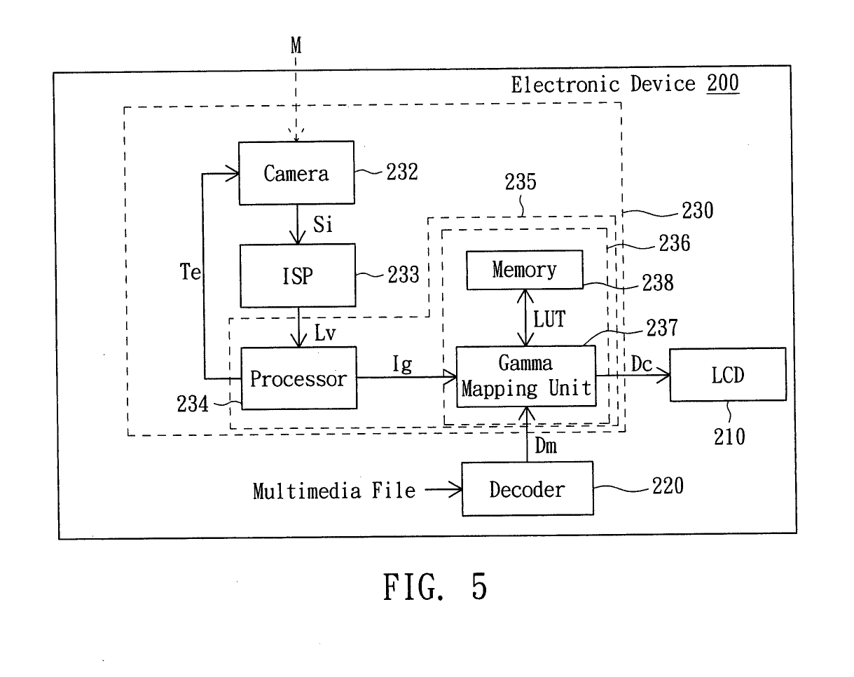

Referring to FIG. 5, a block diagram of an electronic device 200 according to a second embodiment of the invention is shown. The electronic device 200, such as a mobile phone or a PDA, includes a LCD 210, a decoder 220, and a display-related setting adjusting apparatus, such as a luminance compensation apparatus 230. The decoder 220 is used for decoding a multimedia file stored in the electronic apparatus 220 so as to generate decoded multimedia data Dm accordingly.

The multimedia file can be an image file or a video file, and therefore, the decoder 220 can accordingly be a JPEG (Joint Photographic Experts Group) decoder or a MPEG (Moving Picture Experts Group) decoder. The luminance compensation apparatus 230 is used for compensating luminance values of pixels of the decoded multimedia data Dm according to environment luminance, and outputting compensated multimedia data Dc to the LCD 210. The LCD displays the images or videos corresponding to the multimedia data Dc for image/video playback purpose. It is noted that the electronic apparatus 200 is not limited to using the LCD 210 as in the embodiment. The electronic apparatus 200 can also use any other display 210 for displaying the multimedia data Dm.

As shown in FIG. 5, the electronic apparatus 200 comprises an image sensor 232 (i.e. camera 232) and an image signal processing (ISP) unit 233. The images captured by the camera 232 are processed by the ISP unit 233, and the processed image data is input to a luminance compensation unit 236 for compensating luminance values of pixels of the processed image data according to environment luminance. Then, the compensated image data is output to the LCD 210 for image preview purpose.

The luminance compensation apparatus 230 includes a camera 232, an image signal processor (ISP) 233 and a determination device 235. The determination device 235 further includes a processor 234, and a luminance compensation unit 236. Generally speaking, the camera 232 includes a CMOS sensor or a CCD for image sensing. The camera 232 captures images M according to a number of exposure time values Te, and output image signals Si accordingly. The ISP 233 processes the image signals Si, and outputs image luminance values Lv accordingly. The processor 234, such as a central processing unit (CPU), determines a tone reproduction curve (TRC) index (e.g. a gamma curve index Ig) according to the image luminance values Lv and the exposure time values Te.

The processor 234 may have a mapping table for recording the mapping between luminance detection values and gamma curve indexes. The luminance compensation unit 236 is coupled to the processor 234 for compensating luminance values of pixels of the decoded multimedia data Dm according to the gamma curve index Ig and outputting compensated multimedia data Dc to the LCD 210 for display. However, the invention is not limited to using the camera 232, and any kind of image sensing device which can be used to capture images of the surroundings so as to achieve purpose of automatically adjusting the setting of luminance compensation (i.e. dynamically selecting a gamma curve for gamma mapping operation) according to environment luminance information can also be applied in the invention.

The luminance compensation unit 236 includes a TRC mapping unit, e.g. a gamma mapping unit 237, and a memory 238. The memory 238 is used for storing a number of TRC lookup tables, e.g. gamma curve lookup tables (LUT), and the gamma mapping unit 237 selects a gamma curve LUT from the memory 238 according to the gamma curve index Ig so as to perform the corresponding gamma mapping operation on the multimedia data Dm.

Although the luminance compensation unit 236 is exemplified to include a gamma mapping unit 237, and the processor 234 is exemplified to output a gamma curve index Ig according to the image luminance values Lv and exposure time values Te in the embodiment, the luminance compensation unit 236 can also use other TRC mapping units to compensate the multimedia data Dm according to the TRC index. As long as the TRC for mapping the luminance values of pixels of the multimedia data Dm can be dynamically adjusted and selected according to the environment luminance, it will not depart from the scope of the invention.

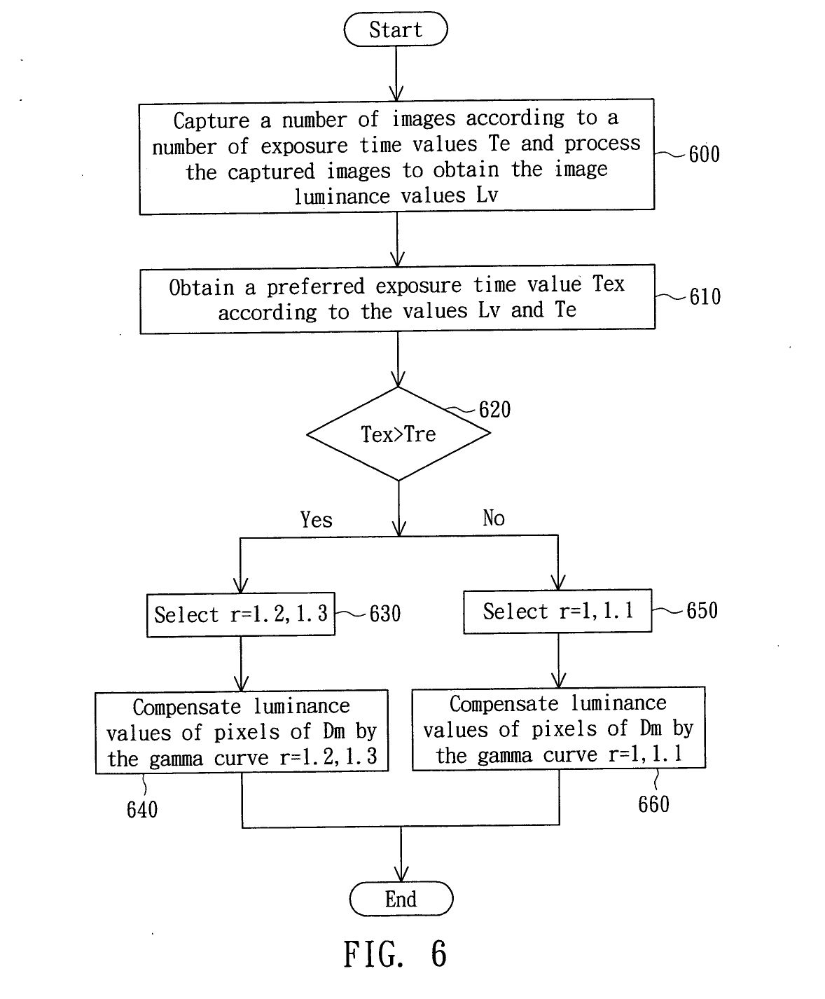

Referring to FIG. 6, a flow chart of the luminance compensation method according to the second embodiment of the invention is shown. First, in step 600, capture a number of images M, by using the camera 232 for instance, according to a number of exposure time values Te. Then, process the captured images so as to obtain image luminance values Lv. The image luminance values carry the environment luminance information. Following that, in step 610, a preferred exposure time value Tex is obtained according to the exposure time values Te and the image luminance values Lv.

The same as the first embodiment, in the second embodiment, a mapping curve of nine exposure time values Te (between 0 and 1/1000) and the measured image luminance values Lv (0˜255) is generated as shown in FIG. 4. The processor 234 controls the camera 232 to capture nine images M according to nine arbitrary exposure time values Te uniformly distributed between 0 and 1/1000. The ISP 233 then processes the captured nine images so as to generate nine image luminance values Lv. Then, the processor 234 generates a mapping curve Cm of the nine exposure time values Te and the nine image luminance values Lv as shown in FIG. 4. Thereafter, the processor 234 bases on a luminance reference value Lr, e.g. 128, to obtain a preferred exposure time value Tex, e.g. 1/250.

Next, in step 620, compare the preferred exposure time value Tex with a predetermined exposure time reference value Tre, e.g. 1/100 sec. The predetermined exposure time reference value Tre is determined according to experiments and experiences. If the preferred exposure time value Tex is greater than the predetermined exposure time reference value Tre, it means the electronic apparatus 200 is located in a relatively dark environment, such as an indoor environment, since longer exposure time is required. Then, the method proceeds to step 630 to select a first gamma curve index, such as γ=1.2 or 1.3 for compensation of luminance values of pixels. Finally, in step 640, the luminance values of pixels of the multimedia data Dm are compensated by using the gamma curve LUT corresponding to the gamma curve index γ=1.2 or 1.3.

If the preferred exposure time value Tex is smaller than the predetermined exposure time reference value Tre, it means the electronic apparatus 200 is located in a relatively bright environment, such as an outdoor environment since shorter exposure time is preferred. Then, the method proceeds to step 650 to select a second gamma curve index, such as γ=1 or 1.1 for luminance compensation of pixels. Finally, in step 660, the luminance values of pixels of the multimedia data Dm are compensated by using the gamma curve LUT corresponding to the gamma curve index γ=1 or 1.1. Therefore, the luminance values of pixels of the multimedia data Dm can be dynamically adjusted and compensated according to the environment luminance to produce more subjectively pleasing experience of image/video viewing for the user, including image preview and image/video playback.

It should be noted that since the above example has only one exposure time reference value Tre, the four gamma curve indexes γ=1, 1.1, 1.2, and 1.3 are divided into two groups, where the first group includes indexes of γ=1, 1.1 and the second group includes indexes γ=1.2, 1.3. When Tex is smaller than Tre, the first group is selected. Otherwise, the second group is selected.

It can be easily understood by the skilled in the art, since there are four gamma curve indexes γ=1, 1.1, 1.2, and 1.3, three exposure time reference values Tre1, Tre2, Tre3 can be provided for selection of gamma curve index. Wherein Tre1 is smaller than Tre2, while Tre2 is smaller than Tre3. When Tex is smaller than Tre1, the gamma curve indexes γ=1 is selected. When Tex is greater than Tre1 and smaller than Tre2, the gamma curve indexes γ=1.1 is selected. When Tex is greater than Tre2 and smaller than Tre3, the gamma curve indexes γ=1.2 is selected. When Tex is greater than Tre3, the gamma curve indexes γ=1.3 is selected.

Therefore, by using the apparatus and method for adjusting display-related setting of an electronic device illustrated in the two embodiments, the display-related setting, such as the luminance of the LCD 110, or the TRC for compensating the luminance values of pixels of multimedia data Dm can be adjusted and selected according to the environment luminance so as to provide better quality of image/video display.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for adjusting display-related setting of an electronic device, comprising:
an image sensing device, for capturing a plurality of images and outputting a plurality of image signals accordingly;
an image signal processing unit, coupled to the image sensing device, for processing the image signals and outputting a plurality of image luminance values accordingly; and
a determination device, coupled to the image sensing device and the image signal processing unit, for controlling the image sensing device to capture the images according to a plurality of exposure time values, and adjusting the display-related setting of the electronic device according to the image luminance values and the exposure time values.

2. The apparatus according to claim 1, wherein the image sensing device comprises a complementary metal oxide semiconductor (CMOS) sensor or a charge coupled device (CCD).

3. The apparatus according to claim 1, wherein the determination device obtains a preferred exposure time value according to the image luminance values and exposure time values, and adjusts the display-related setting of the electronic device according to the preferred exposure time value.

4. The apparatus according to claim 1, wherein the electronic device comprises a display having a lighting module, the display-related setting is adjusting the luminance of the lighting module, and the determination device is a processor for controlling the luminance of the lighting module.

5. The apparatus according to claim 1, wherein the processor is a central processing unit (CPU).

6. The apparatus according to claim 4, wherein the display is a transmissive liquid crystal display (LCD) or a transflective LCD, and the lighting module is a backlight module.

7. The apparatus according to claim 6, wherein the lighting module is a light emitting device (LED) backlight module, the apparatus further comprises a pulse width modulation (PWM) controller coupled to the processor for outputting a PWM signal to the LED backlight module, and the processor adjusts the luminance of the LED backlight module by changing the duty of the PWM signal according to the image luminance values and the exposure time values.

8. The apparatus according to claim 4, wherein the display is a reflective LCD and the lighting module is a frontlight module.

9. The apparatus according to claim 1, wherein the electronic device is for displaying multimedia data on a display, and the display-related setting is selecting a tone reproduction curve (TRC) for compensating luminance values of pixels of the multimedia data.

10. The apparatus according to claim 9, wherein the determination device further comprises a processor and a luminance compensation unit, the processor outputs a TRC index according to the image luminance values and the exposure time values, and the luminance compensation unit adjusts the TRC for compensating the luminance values of pixels of the multimedia data according to the TRC index.

11. The apparatus according to claim 10, wherein the luminance compensation unit further comprises a TRC mapping unit and a memory, the memory is for storing a plurality of TRC lookup tables (LUT), and the TRC mapping unit selects a TRC LUT from the memory for compensating the luminance values of pixels of the multimedia data according to the TRC index.

12. The apparatus according to claim 10, wherein the TRC is a gamma curve.

13. The apparatus according to claim 10, wherein the electronic device is a mobile phone or a personal digital assistant (PDA).

14. A method for adjusting display-related setting of an electronic device having an image sensing device, the method comprising:
(a) capturing a plurality of images by the image sensing device according to a plurality of exposure time values and obtaining a plurality of image signals accordingly;
(b) processing the image signals and obtaining a plurality of image luminance values accordingly; and
(c) adjusting the display-related setting of the electronic device according to the image luminance values and the exposure time values.

15. The method according to claim 14, wherein the image sensing device is a camera embedded in the electronic device.

16. The method according to claim 14, wherein the step (c) comprises:
(c-1) obtaining a preferred exposure time value according to the image luminance values and the exposure time values; and
(c-2) adjusting the display-related setting of the electronic device according to a comparison result of the preferred exposure time value and a predetermined exposure time reference value.

17. The method according to claim 16, wherein the step (c-1) comprises generating a mapping curve of the image luminance values and the exposure time values and obtaining the exposure time value corresponding to a luminance reference value as the preferred exposure time value via the mapping curve.

18. The method according to claim 14, wherein the display-related setting is adjusting the luminance of a display of the electronic device.

19. The method according to claim 18, wherein the display is a transmissive LCD, and the step (c-2) comprises decreasing the luminance of the display if the preferred exposure time value is larger than the exposure time reference value, and vice versa.

20. The method according to claim 18, wherein the display is a reflective LCD or a transflective LCD, and the step (c-2) comprises increasing the luminance of the display if the preferred exposure time value is larger than the exposure time reference value, and vice versa.

21. The method according to claim 18, wherein the display is a LCD comprising a LED backlight module, and the step (c-2) comprises adjusting the duty of a PWM signal for controlling the LED backlight module and thus adjusts the luminance of the LED backlight module according to a comparison result of the image luminance values and the exposure time values.

22. The method according to claim 14, wherein the display-related setting is selecting a TRC for compensating luminance values of pixels of multimedia data.

23. The method according to claim 22, wherein the step (c-2) comprises:
(c-2-1) obtaining a TRC index according to the comparison result of the preferred exposure time value and the predetermined exposure time reference value; and
(c-2-2) adjusting the TRC for compensating the luminance values of pixels of the multimedia data according to the TRC index.

24. The method according to claim 23, wherein the TRC index is a gamma curve index, and the step (c-2-1) comprises selecting a first gamma curve index if the preferred exposure time value is larger than the exposure time reference value and selecting a second gamma curve index if the preferred exposure time value is not larger than the exposure time reference value, wherein the first gamma curve index is larger than the second gamma curve index.
